(19) United States
(12) Patent Application Publication
(10) Pub. No.: US 2015/0002311 A1
(43) Pub. Date: Jan. 1, 2015

(54) ACTIVE BEACON FOR VULNERABLE ROAD USERS

(71) Applicant: NXP B.V., Eindhoven (NL)

(72) Inventor: Bernhard Spiess, Gratkorn (AT)

(21) Appl. No.: 14/314,968

(22) Filed: Jun. 25, 2014

(30) Foreign Application Priority Data
Jul. 1, 2013 (EP) 13174502.8

(51) Int. Cl. G08G 1/16

(52) U.S. Cl. CPC G08G 1/166; G08G 1/163
USPC 340/901

(57) ABSTRACT

There is described a combined central locking and collision protection device for an automotive vehicle. The described device comprises (a) an RF receiver adapted to receive a remote control signal from a remote control device and a beacon signal from a portable protection device, and (b) a processing unit, wherein the processing unit is adapted to generate a control signal for an automotive central locking system in response to receiving the remote control signal and to generate a warning signal in response to receiving the beacon signal. There is also described a portable protection device, a system, and a vehicle. Furthermore, there is described a method of protecting vulnerable road users.

### FIELD OF THE INVENTION

The present invention relates to the field of safety systems for motorized vehicles, in particular to safety systems capable of assisting vehicle drivers with detection of vulnerable road users, e.g. pedestrians and cyclists.

### ART BACKGROUND

Various systems for reducing the risk of collision between motorized vehicles and other road users are known in the art.

EP 2 101 305 A2 relates to an on-board communication terminal that can notify a driver in case of collision danger. The system utilizes communication of position data between vehicles and pedestrians and processing of the received position data.

WO 2009086636 A1 relates to a system employing radio frequency identification (RFID) based proximity sensing, warning and machine shut-down for collision avoidance between personnel and articulated or mobile industrial machinery.

These systems are complex and expensive due to the use of dedicated communication and processing equipment in the vehicle.

Other systems involve infrared cameras which may assist a driver in detecting pedestrians under conditions with limited sight, such as during dark hours or during difficult weather conditions involving e.g. for, rain, mist etc. Such systems are limited to the line of sight and may thus not enable the driver to see another road user early enough to avoid a dangerous situation.

There may thus be a need for a way of effectively improving traffic safety which can be easily and flexibly implemented at a low price.

### SUMMARY OF THE INVENTION

This need may be met by the subject matter according to the independent claims. Advantageous embodiments of the present invention are set forth in the dependent claims.

According to a first aspect there is provided a combined central locking and collision protection device for an automotive vehicle. The described device comprises (a) an RF receiver adapted to receive a remote control signal from a remote control device and a beacon signal from a portable protection device, and (b) a processing unit, wherein the processing unit is adapted to generate a control signal for an automotive central locking system in response to receiving the remote control signal and to generate a warning signal in response to receiving the beacon signal.

This aspect is based on the idea that one and the same device for a motorized vehicle is used to receive remote control signals from a remote control device, such as a car key, and beacon signals from a portable protection device, such as a small RF device carried by a pedestrian. Thereby, the motorized vehicle can be equipped with both a remote control function (central locking system) and a collision protection system without the need for additional hardware.

In the present context, the term “remote control device” may particularly denote a device for performing various functions comfort functions relating to a motorized vehicle in a state where it is not driving, such as locking and unlocking a central locking system of the vehicle, turning a vehicle heater on or off, or transmitting a request for information about temperature, fuel level or other parameters of the vehicle.

In the present context, the term “beacon signal” may particularly denote an RF signal transmitted at regular intervals within the same frequency band that is used by the remote control device.

In the present context, the term “RF receiver” may particularly denote a functional unit capable of receiving RF signals. Thus, the RF receiver may be constituted by a dedicated receiver or preferably by a unit which is both capable of receiving and transmitting, i.e. a so-called RF transceiver.

In the present context, the term “processing unit” may particularly denote a hardware and/or software unit capable of processing the received signal in various ways and of generating control signals based on the received signals.

In the present context, the term “warning signal” may in particular denote a signal for use by another entity of the vehicle in order to output a warning to a driver, e.g. by activating a warning indicator, such as a lamp and/or a loudspeaker, or by displaying a warning as text or graphics on a vehicle display.

The combined central locking and collision protection device according to the first aspect provides a wide variety of useful functions for a vehicle user in relation to a wide range of situations and is thereby capable of improving both the user friendliness for the car owner (or driver) as well as improving security for vulnerable road users in the vicinity of the vehicle. All this can be achieved with a minimum amount of hardware and consequently in a cost efficient manner.

According to an embodiment, (a) the RF receiver is adapted to receive the remote control signal and the processing unit is adapted to generate the control signal in a mode of operation corresponding to a non-driving vehicle, and (b) the RF receiver is adapted to receive the beacon signal and the processing unit is adapted to generate the warning signal in a mode of operation corresponding to a driving vehicle.

In the present context, the term “non-driving vehicle” may particularly denote a mode of operation where the vehicle is not used for transportation. More specifically, this mode of operation may particularly refer to a situation where the vehicle is standing still at a parking lot or a similar place while the vehicle owner/user is preparing to use the vehicle for transportation or has just used the vehicle for transportation.

Similarly, the term “driving vehicle” may particularly denote a mode of operation where the vehicle is used for transportation. This may particularly include situations of temporary non-driving, such as at a red traffic light.

In other words, the RF receiver and processing unit are capable of handling received signals in different ways depending on whether the vehicle is being used for transportation or not.

According to a further embodiment, (a) the processing unit is adapted to estimate a distance between the device and the portable protection device based on the strength of the received beacon signal, and (b) the processing unit is adapted to generate the warning signal only if the estimated distance is below a predetermined threshold value, and/or the processing unit is adapted to include the estimated distance as information in the warning signal.

The processing unit may e.g. utilize RSSI (Received Signal Strength Indication) techniques to estimate the distance.

The processing unit may determine to generate the warning signal only if the estimated distance is below a predetermined threshold value, such as 1000 m, 800 m, 500 m, 400 m, 250 m or 100 m. The specific threshold value may be determined in consideration of possible additionally available information, such as time of day, season, speed, geographic area, etc.

Furthermore, the processing unit may additionally or alternatively incorporate the estimated distance in the warning signal. Thereby, a warning indicator or display device may use the distance information to present a warning in such a manner that the vehicle user is able to determine a level of collision danger, e.g. by being presented with an intensive light or sound signal in cases of small distances and a less intensive signal in cases of larger distances.

According to a further embodiment, the device further comprises an RF transmitter adapted to (a) transmit a remote response signal to the remote control device in response to receiving the remote control signal and (b) to transmit a beacon response signal to the portable protection device in response to receiving the beacon signal.

In the present context, the term “RF transmitter” may particularly denote a functional unit capable of transmitting RF signals. Thus, the RF transmitter may be constituted by a dedicated transmitter or preferably by a unit which is both capable of receiving and transmitting, i.e. a so-called RF transceiver. In the latter case, a single RF transceiver may act as both the “RF receiver” and the “RF transmitter” in the terminology of the present application.

In the present context, the term “remote response signal” may particularly denote a signal containing information requested by the received remote control signal. The information may e.g. relate to fuel or battery levels, temperature within the car or other information of relevance to the owner prior to or after using the vehicle for transportation.

In the present context, the term “beacon response signal” may particularly denote a signal adapted to inform the portable protection unit that the beacon signal has been received and, optionally, request a confirmation or other additional information from the portable protection unit.

According to a further embodiment, the RF receiver is adapted to receive a confirmation signal from the portable protection device in response to the beacon response signal.

According to a further embodiment, the processing unit is adapted to estimate the distance between the device and the portable protection device based on a time of flight measurement, and/or the confirmation signal includes position data indicative of the position of the portable protection device.

By transmitting the beacon response signal and receiving a subsequent confirmation signal from the portable protection unit, the processing unit may measure a time of flight and based thereon perform an estimation of the distance between the device (i.e. the vehicle) and the portable protection device. Thereby, a more precise estimate of the distance may usually be obtained in comparison to an estimation based solely on signal strength.

By also receiving position data indicative of the position of the portable protection device, the processing unit may further include these position data in the warning signal. Thereby, the actual position of the portable protection unit may be used by a unit receiving the warning signal.

According to a further embodiment, the device further comprises an interface adapted to supply the warning signal to an automotive navigation system.

Thereby, the navigation system may be used to present a warning to the user in form of e.g. sound and/or text and/or graphics. In case the warning signal includes position data received from the portable protection device, the warning may thus be displayed as a graphic symbol on a display of the navigation system such that the driver can see where the portable protection unit is located relative to the position of the vehicle.

According to a second aspect, there is provided a portable protection device for use with a combined central locking and collision protection device according to the above aspect or any of the above embodiments. The described device comprises an RF transmitter adapted to repeatingly transmit a beacon signal.

In the present context, the term “RF transmitter” may particularly denote a functional unit capable of transmitting RF signals. Thus, the RF transmitter may be constituted by a dedicated transmitter or preferably by a unit which is both capable of receiving and transmitting, i.e. a so-called RF transceiver.

In the present context, the term “repeatingly transmit a beacon signal” may in particular denote transmitting a message with a predetermined frequency of repetition, such as two times per second, once every second, or once every two seconds.

Each message of the beacon signal preferably contains a unique ID, such as a number. Thereby, a receiving device can distinguish between portable devices in case more than one such portable device is within range of the receiving device.

The RF transmitter is preferably adapted to operate in the ISM bands (industrial, scientific and industrial bands) of 315 MHz, 434 MHz, 868 MHz or 915 MHz. Alternatively, the RF transmitter is adapted to perform UWB (ultra wide band) communication in frequency bands such as 2.4 GHz or 5 GHz.

The RF transmitter is preferably designed to provide a transmission range of about 1 km or less, such as between 500 m and 1 km.

The portable protection device is preferably designed to be carried in a pocket or a rucksack, such as a school bag. The device may further be designed such that it can be mounted on a bike, skateboard or the like.

The device is preferably powered by batteries, such as AA type batteries. The batteries may be rechargeable. In the latter case, the device may further comprise a solar panel for re-charging the batteries.

According to an embodiment, the device further comprises an RF receiver adapted to receive a beacon response signal from a combined central locking and collision protection device, wherein the RF transmitter is further adapted to transmit a confirmation signal in response to receiving the beacon response signal from the combined central locking and collision protection device.

In the present context, the term “RF receiver” may particularly denote a functional unit capable of receiving RF signals. Thus, the RF receiver may be constituted by a dedicated receiver or preferably by a unit which is both capable of receiving and transmitting, i.e. a so-called RF transceiver. In the latter case, a single RF transceiver may act as both the “RF receiver” and the “RF transmitter” in the terminology of the present application.

By receiving a beacon response signal and transmitting a confirmation signal in response thereto, the combined central locking and collision protection device may be able to estimate the distance to the portable device with high precision using e.g. ToF (time of flight) techniques. Furthermore, by receiving a confirmation, the combined central locking and collision protection device may reduce the number of possible false alarms.

According to a further embodiment, the device further comprises a motion detector adapted to detect whether the device is moving, wherein the RF transmitter is adapted to repeatingly transmit the beacon signal in response to a control signal from the motion detector.

The use of a motion detector may limit the transmission of the beacon signal to cases where the user is moving or has been moving recently. In other words, the transmission of the beacon signal may be turned on as soon as the motion detector detects that the portable device is moving. Thereafter, the transmission of the beacon signal may be turned off again when no movement has been detected for a predetermined period of time, such as 5 minutes, 10 minutes, 15 minutes, 20 minutes, 25 minutes, or 30 minutes.

Thereby, it can be prevented that the battery is drained while the carrier of the portable device is not on the road, e.g. while a child is in school. As a further option, the portable protection device may include a light sensor for determining whether it is night or day. This information can be used in a variety of ways, e.g. by shutting off or reducing the transmission of the beacon signal in broad daylight, where drivers can be expected to see the carrier of the portable device.

According to a further embodiment, the device further comprises an interface for communicating with a mobile communication device.

The interface may be designed to communicate with the mobile communication device, such as a smart phone, by any suitable means, including a GPS or data interface, a Bluetooth interface or an NFC interface (near field communication).

Thereby, the portable protection device may receive data information, such as GPS or other position data, from the mobile communication unit and transmit this information to the combined central locking and collision protection device on request.

According to a third aspect, there is provided a combined central locking and collision protection system. The described system comprises (a) a combined central locking and collision protection device according to the first aspect or any of the above embodiments, and (b) a portable protection device according to the second aspect or any of the above embodiments.

By combining the combined central locking and collision protection device according to the first aspect with the portable protection unit according to the second aspect, a cost effective and simple way of providing improved traffic security for vulnerable road users, such as children, pedestrians and cyclists, can be obtained without adding hardware to the motorized vehicle. More specifically, the part of the system which is implemented in the vehicle is a dual function device which uses the same hardware for remotely controlling and performing central locking and comfort functions while the vehicle is not used for transportation and for generating warning signals to the driver while the vehicle is used for transportation.

According to a fourth aspect, there is provided an automotive vehicle comprising a combined central locking and collision protection device according to the first aspect or any of the above embodiments.

The vehicle according to this aspect is capable of providing both remote control functions and improved security with regard to vulnerable road users with a minimum of hardware and thus at an attractive price.

According to a fifth aspect, there is provided a method of protecting vulnerable road users, the method comprising (a) repeatingly transmitting a beacon signal from a portable protection unit carried by a vulnerable road user, (b) receiving the beacon signal at an automotive vehicle comprising a combined central locking and collision protection device, and (c) generating a warning signal in response to receiving the beacon signal.

The method is generally based on the idea of using one and the same device for a motorized vehicle to receive remote control signals from a remote control device and beacon signals from a portable protection device. Thereby, the hardware of the motorized vehicle can be used in an optimized manner.

According to an embodiment, the method further comprises (a) estimating the distance between the automotive vehicle and the portable protection unit, and (b) generating the warning signal only if the estimated distance is below a predetermined threshold value, and/or (c) including the estimated distance in the warning signal. It should be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless otherwise indicated, in addition to any combination of features belonging to one type of subject matter, also any combination of features relating to different subject matters, in particular a combination of features of the method type claims and features of the apparatus type claims, is disclosed with this document.

The aspects defined above and further aspects of the present invention are apparent from the examples of embodiment to be described hereinafter and are explained with reference to the examples of embodiment. The invention will be described in more detail hereinafter with reference to examples of embodiment to which the invention is, however, not limited.

### BRIEF DESCRIPTION OF THE DRAWING

FIG. 1 shows a schematic illustration of communication between a combined central locking and collision protection device and a portable protection device in accordance with an embodiment.

### DETAILED DESCRIPTION

The illustration in the drawing is schematic. It is noted that in different figures, similar or identical elements are provided with the same reference signs or with reference signs, which differ only within the first digit.

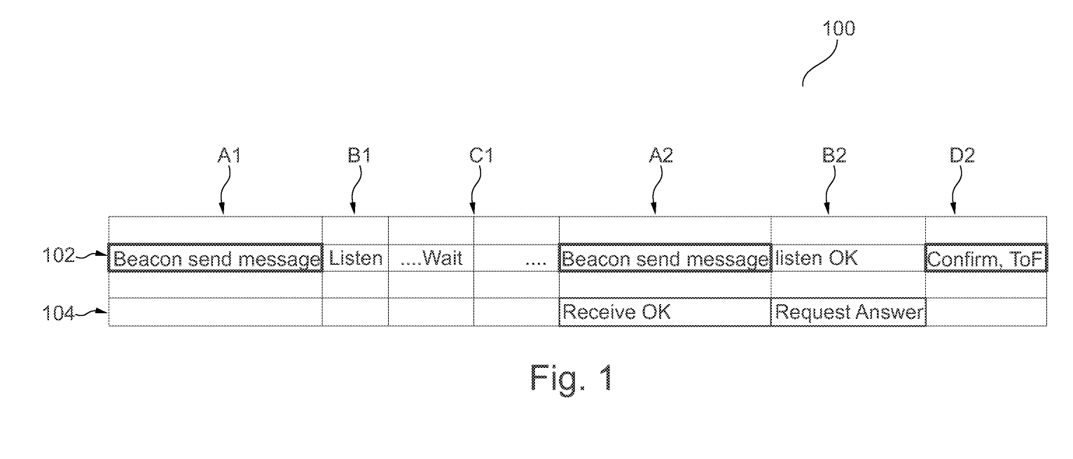

FIG. 1 shows a schematic illustration of communication between a combined central locking and collision protection device and a portable protection device in accordance with an embodiment. More specifically, the illustration shows a table 100 which includes columns A1, B1, C1, A2, B2, and D2 representing a series of events during communication. Furthermore, the table 100 includes a lower row 104 indicating specific events occurring at the combined central locking and collision protection device. Finally, the table 100 includes an upper row 102 indicating specific events occurring at the portable protection device.

In the first, i.e. the left-most column A1, the portable protection device transmits a beacon message. Following the transmission of the beacon message, the portable protection device listens for a reply as indicated in column B1. As no reply is received, the portable protection device waits, e.g. for 1 second, as indicated in column C1 before it transmits a new beacon message as indicated in column A2. Now, as also indicated in column A2, lower row 104, the beacon message is received by the combined central locking and collision protection device. That is, the combined central locking and collision protection device and the portable protection unit are now within range of each other. In the next column B2, the portable protection device listens (like in the previous column B1) and this time receives a request for a confirmation transmitted by the combined central locking and collision protection device. Finally, in column D2, the portable protection device transmits a confirmation message. Once received at the combined central locking and collision protection device, the confirmation message allows the combined central locking and collision protection device to estimate the distance to the portable protection device using RSSI and/or time-of-flight techniques.

Thereafter (not shown), the combined central locking and collision protection device determines whether the distance to the portable protection device is below a threshold, e.g. 100 m, such that a risk of collision exists. If it is determined that a risk of collision exists, the combined central locking and collision protection device generates a warning signal. The warning signal is transmitted to an appropriate output device which draws the vehicle driver's attention to the fact that a risk of collision with a carrier of the portable protecting device exists by causing output of sound and/or light signals, e.g. by means of a display of a navigation system. If possible, e.g. if the confirmation message includes positional data, the warning signal may allow the navigation system to indicate the position of the carrier of the portable protecting unit relative to the vehicle such that the driver can decide to move on, slow down or break strongly.

In this exemplary embodiment, the combined central locking and collision protection device detects whether the vehicle in which it is mounted is rolling (driving) or not. When the vehicle is not rolling (and the engine is turned off), the combined central locking and collision protection device listens for messages relating to performance of central locking and comfort functions. However, when the vehicle is rolling (and the engine is turned on), the combined central locking and collision protection device listens for messages from portable protection devices. As mentioned above, the collision protection device of this exemplary embodiment transmits one beacon message every second. In this respect, it is noted that a car driving at a speed of 100 km/h will drive approximately 28 m per second. Assuming a communication distance of maximum 1000 m (typically around 500 m), the time polling interval of 1 second will be appropriate as it will (in most situation) provide the driver sufficient time to react and at the same time avoid draining the power source of the portable protection device too fast.

The energy consumption of a system with rather high output power (such as e.g. +18 dBm) would be in the range of 50 mA for transmit operation, assumed bitrates would be in the order of 2.6 kbit/s, assumed protocol length including run-in, header and payload would be about 100 bits, payload could comprise a unique ID and incorporate a cipher crypto algorithm, yielding a communication time of approximately 40 ms. This would result in an energy consumption of 2 mA on average. Hence, with AA type batteries, a typical operation time of 700 hours may be obtained.

In a simplified embodiment, the receiver in the car would always be listening (when the vehicle is moving) and, on the event of a received beacon message, the RSSI would be evaluated. If this evaluation is done on a continuous basis, it is possible to evaluate how the object is moving in respect to the car. To secure the system from false alarms, a bi-directional communication can be established as described above. In this case, after transmitting, the portable protection device always listens for a response. If the car understands the beacon message, it requests a confirmation. The latter is advantageously combined with a time of flight round trip measurement (ToF) which allows an even more precise determination of the distance between vehicle and portable device.

It is noted that, unless otherwise indicated, the use of terms such as “upper”, “lower”, “left”, and “right” refers solely to the orientation of the corresponding drawing.

It should be noted that the term “comprising” does not exclude other elements or steps and that the use of the articles “a” or “an” does not exclude a plurality. Also elements described in association with different embodiments may be combined. It should also be noted that reference signs in the claims should not be construed as limiting the scope of the claims.

1. A combined central locking and collision protection device for an automotive vehicle, the device comprising
an RF receiver adapted to receive a remote control signal from a remote control device and a beacon signal from a portable protection device, and
a processing unit,
wherein the processing unit is adapted to generate a control signal for an automotive central locking system in response to receiving the remote control signal and to generate a warning signal in response to receiving the beacon signal.

2. The device according to claim 1, wherein
the RF receiver is adapted to receive the remote control signal and the processing unit is adapted to generate the control signal in a mode of operation corresponding to a non-driving vehicle, and
the RF receiver is adapted to receive the beacon signal and the processing unit is adapted to generate the warning signal in a mode of operation corresponding to a driving vehicle.

3. The device according to claim 1,
wherein
the processing unit is adapted to estimate a distance between the device and the portable protection device based on the strength of the received beacon signal, and
the processing unit is adapted to generate the warning signal only if the estimated distance is below a predetermined threshold value, and/or the processing unit is adapted to include the estimated distance as information in the warning signal.

4. The device according to claim 1, further comprising an RF transmitter adapted to transmit a remote response signal to the remote control device in response to receiving the remote control signal and to transmit a beacon response signal to the portable protection device in response to receiving the beacon signal.

5. The device according to claim 1, wherein the RF receiver is adapted to receive a confirmation signal from the portable protection device in response to the beacon response signal.

6. The device according to claim 1, wherein
the processing unit is adapted to estimate the distance between the device and the portable protection device based on a time of flight measurement, and/or
the confirmation signal includes position data indicative of the position of the portable protection device.

7. The device according to claim 1, further comprising
an interface adapted to supply the warning signal to an automotive navigation system.

8. A portable protection device for use with a combined central locking and collision protection device according to claim 1, the device comprising
an RF transmitter adapted to repeatingly transmit a beacon signal.

9. The device according to claim 1, further
comprising
an RF receiver adapted to receive a beacon response signal from a combined central locking and collision protection device,
wherein the RF transmitter is further adapted to transmit a confirmation signal in response to receiving the beacon response signal from the combined central locking and collision protection device.

10. The device according to claim 8, further comprising
a motion detector adapted to detect whether the device is moving,
wherein the RF transmitter is adapted to repeatingly transmit the beacon signal in response to a control signal from the motion detector.

11. The device according to claim 8, further comprising
an interface for communicating with a mobile communication device.

12. A combined central locking and collision protection system, the system comprising
a combined central locking and collision protection device according to any of preceding claims 1 to 7, and
portable protection device according to claim 8.

13. An automotive vehicle comprising a combined central locking and collision protection device according to any of preceding claims 1 to 7.

14. A method of protecting vulnerable road users, the method comprising
repeatingly transmitting a beacon signal from a portable protection unit carried by a vulnerable road user,
receiving the beacon signal at an automotive vehicle comprising a combined central locking and collision protection device, and
generating a warning signal in response to receiving the beacon signal.

15. The method according to claim 1, further
comprising
estimating the distance between the automotive vehicle and the portable protection unit, and
generating the warning signal only if the estimated distance is below a predetermined threshold value, and/or including the estimated distance in the warning signal.
